(19) United States
(12) Patent Application Publication
(10) Pub. No.: US 2017/0260945 A1
(43) Pub. Date: Sep. 14, 2017

(54) Fuel Rail

(71) Applicant: Hitachi Automotive Systems, Ltd., Hitachinaka-shi, Ibaraki (JP)

(72) Inventors: Masahiro SOMA, Hitachinaka (JP); Hiroshi ONO, Hitachinaka (JP); Masaru KAWAI, Hitachinaka (JP); Shinya NAKATANI, Hitachinaka (JP); Keiichi URAKI, Hitachinaka (JP)

(21) Appl. No.: 15/511,311

(22) PCT Filed: Jul. 10, 2015
(86) PCT No.: PCT/JP2015/069817

§ 371 Date: Mar. 15, 2017

(30) Foreign Application Priority Data
Sep. 17, 2014 (JP) 2014-188603

(51) Int. Cl. F02M 55/02; F02M 61/16; F02M 61/14

(52) U.S. Cl. CPC F02M 55/025; F02M 61/14; F02M 61/168

(57) ABSTRACT

An object of the present invention is to provide a fuel rail which can realize weight reduction while enhancing the strength of a cross-hole portion. A fuel rail for an internal combustion engine according to the present invention includes a cylindrical fuel rail body 1 and an injector mounting portion 2 in which a hole 2d to supply a fuel to an injector is formed, and the injector is mounted. The injector mounting portion 2 is integrally molded in the fuel rail body 1 such that the fuel supply hole 2d crosses a center hole 1a of the fuel rail body 1. plurality of injector mounting portions 2 is included along a longitudinal direction of the fuel rail body 1. A thickness of a root portion of the injector mounting portion 2 is thicker than a thickness of the fuel rail body 1 disposed between two adjacent injector mounting portions 2.

### TECHNICAL FIELD

The present invention relates to a fuel rail for supplying a high-pressure fuel to an injector.

### BACKGROUND ART

In a gasoline engine in which gasoline is used as a fuel, a fuel pressure to be supplied to a fuel injection valve is recently highly pressurized. Conventionally, a fuel rail described in JP 2013-199943 A (PTL 1) is known as a fuel rail in which a fuel injection valve is mounted and which supplies fuel to the fuel injection valve. The fuel rail described in PTL 1 includes an injector holder assembly including an injector cup to assemble a fuel injection valve. The injector cup includes a housing in which an inner space is included, and one end is opened (refer to paragraph 0025). This injector cup is made of a member different from the fuel rail (refer to FIG. 2). Conventionally, a technique to join an injector cup to a fuel rail, for example, by brazing is known.

On the other hand, a common rail to be used in a diesel engine is described in JP 2007-146725 A (PTL 2). An outer dimension of the common rail described in PTL 2 is same as a conventional dimension. An inner dimension or an accumulator hole is divided into a small diameter portion and a large diameter portion, and a cross hole opened on an inner peripheral surface of the accumulator hole is provided in the small diameter portion (refer to Abstract). In the common rail, a minimum thickness of the cross hole portion can be increased by which a cross hole is opened in the small diameter portion, and a rail damage can be avoided (refer to Abstract). On the other hand, an accumulation volume decreased in the small diameter portion is covered by the large diameter portion. Therefore, a total volume of the accumulator hole is not decreased (refer to Abstract). Further, in the common rail in PTL 2, a rail body, a piping joint, and a stay 22 are integrally molded by forging. The piping joint connects a high pressure pump piping and an injector piping. The stay 22 mounts the rail body to a fixing member of such as engine (refer to paragraph 0035). In the common rail in PTL 2, a high pressure pump piping or an injector piping is connected to one end portion of an inside/outside communication hole formed at a center of the piping joint, and another end portion of the inside/outside communication hole is communicated to a cross hole.

### CITATION LIST

### Patent Literature

PTL 1: JP 2013-199943 A

PTL 2: JP 2007-146775 A

### SUMMARY OF INVENTION

### Technical Problem

In a fuel rail described in PTL 1, an injector cup is made of a material different from the fuel rail and joined to the rail by such as brazing. A large stress is generated by a fuel pressure at a joint between the injector cup and the fuel rail. As a fuel pressure is highly pressurized, a stress generated at the joint is increased, and the joint does not have a sufficient strength to withstand the stress. Therefore, in fuel rail is which an injector cup is joined, a high pressurization is limited at a relatively low fuel pressure. On the other hand, in the common rail in PTL 2, a rail body and a piping joint are integrally molded by forging, and therefore the common rail is advantageous to increase a fuel pressure. Especially, in the common rail in PTL 2, a minimum thickness of a cross hole portion is increased by which a cross hole is opened in a small diameter portion in which a wall thickness is increased by reducing an inner diameter of an accumulator hole. As a result, the common rail in PTL 2 prevents that a rail is damaged from a cross hole portion even if stress concentration is generated at the cross hole portion by accumulation of an ultra high pressure fuel. However, the common rail in PTL 2 has an issue that the weight of a rail body is increased since a wail thickness of the railbody is increased. In PTL 2, is issue is not sufficiently considered.

An object of the present invention is to provide a fuel rail for an internal combustion engine, which can increase the strength of a cross-hole portion and realize weight reduction.

### Solution to Problem

To achieve the above-described object, in a fuel rail for an internal combustion engine according to the present invention, a fuel rail body and an injector mounting portion (injector cup) in which an injector is mounted are integrally molded, and the thickness of a root portion of the injector cup with respect to the fuel rail body is set to be thicker than the thickness of a fuel rail body portion in which the injector cup is formed.

### Advantageous Effects of Invention

According to the present invention, the wall thickness of a root portion of the injector mounting portion is set to be thicker than the wall thickness of a fuel rail body portion in which an injector cup is formed. Accordingly, while increasing the strength of a portion where a hole formed in an injector mounting portion and a hole formed in a fuel rail body are crossed, weight reduction of a fuel rail for an internal combustion engine can be realized.

An issue, a configuration, and an effect other than the above are clarified descriptions of the following embodiment.

### BRIEF DESCRIPTION. OF DRAWINGS

FIG. 1 is a schematic view illustrating an outline of a supply system it which a fuel rail according to an embodiment of the present invention is applied to a direct-injection internal combustion engine.

FIG. 2 is a view schematically illustrating an arrangement of a fuel rail, an injector, and a high-pressure fuel pump.

FIG. 3A is a side sectional view of a fuel rail and illustrates a sectional surface which is in parallel with an axial direction (longitudinal direction) of the fuel rail body and a direction projecting from the fuel rail body of an injector cup and cut on a place including a center line of the fuel rail body.

FIG. 3B is an appearance view when viewed from an upper surface side of a fuel rail.

FIG. 3C is a side surface view of a fuel rail.

FIG. 4A is an enlarged sectional view of an IVA portion in FIG. 3A.

FIG. 4B is an enlarged overall view when FIG. 4A is viewed from a direction of an arrow IVA.

FIG. 4C is a sectional view illustrating a sectional surface along arrows VC-VC in FIG. 4B.

FIG. 4D is an enlarged sectional view as in FIG. 4A and illustrates a state in which an injector is assembled.

FIG. 5 is a sectional view illustrating an enlarged end portion of a fuel rail body.

FIG. 6A is an appearance view when a fuel rail material molded by forging is viewed from a lower side.

FIG. 6B is a side surface view of the fuel rail material.

FIG. 6C is an appearance view when the fuel rail material is viewed from an IVC direction in FIG. 6B

FIG. 7A is an appearance view when a fuel rail in which a fitting is assembled is viewed from an upper side.

FIG. 7B is a side surface view illustrating a state in which a fuel rail in which a fitting 7 is assembled is fixed to an engine block.

FIG. 7C is a sectional view illustrating a sectional surface indicated by arrows VIIC-VIIC in FIG. 7B.

### DESCRIPTION OF EMBODIMENT

An embodiment of the present invention will be described below.

### First Embodiment

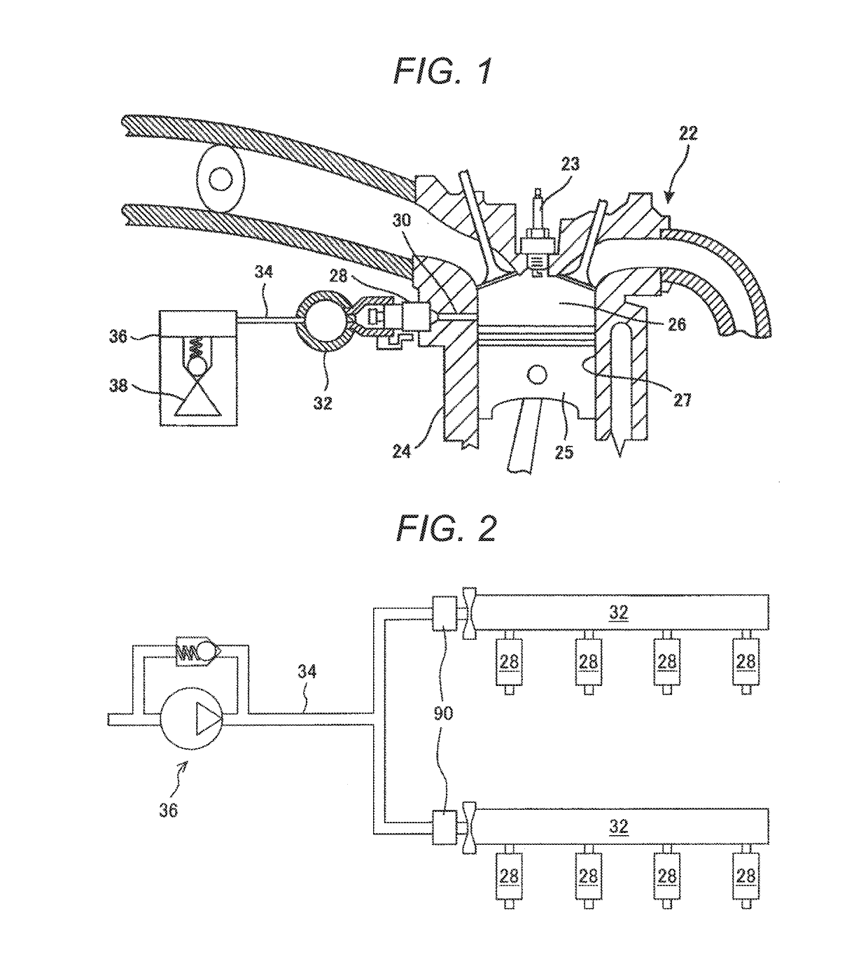

First, a fuel supply system of a direct-injection internal combustion engine in which a fuel rail for an internal combustion engine according to the present invention (hereinafter called a fuel rail) will be described with reference to FIGS. 1 and 2. A gasoline direct-injection internal combustion engine in which gasoline is used as a fuel (hereinafter called an engine) will be described below. The fuel rail according to the present invention is applicable to a diesel engine by partially changing a structure (for example, an injector attaching structure).

FIG. 1 is a schematic view illustrating an outline of a fuel supply system in which a fuel rail according to an embodiment of the present invention is applied to a direct-injection internal combustion engine 22. The engine 22 includes an engine block 24 including a cylinder head. The engine block 24 includes at least one or multiple internal combustion chambers 26.

A spark plug 23 starts fuel combustion in a combustion chamber 26 and drives a piston 25 reciprocably mounted to a cylinder 27 in the engine block 24. Combustion products by fuel combustion is discharged from an exhaust manifold.

A direct injection injector (fuel injection valve) 28 is provided in each combustion chamber 26. Each fuel injection valve 28 is mounted to a passage (through hole) 30 formed to the engine block 24, and a nozzle tip portion in which a fuel injection hole is formed faces the combustion chamber 26.

The injector 28 is fluidally connected to a fuel rail 32. The fuel rail 32 is fluidally connected to a high-pressure fuel pump 36 via a fuel pipe 34. The high-pressure fuel pump 36 generally includes a cam pump including a cam 38 rotated by an engine. Further, the fuel rail 32 is fixed to the engine block 24 via a bracket (not illustrated).

FIG. 2 is view schematically illustrating an arrangement of the fuel rail 32, the injector 28, and the high-pressure fuel pump 36. Here, the high-pressure fuel pump 36 is connected to one or more fuel rails 32 via the fuel pipe 34. To reduce propagation of fuel pump pulsation to the fuel rail 32 and the injector 28, a fuel reservoir 90 is fluidally provided to the fuel pipe 34 in series. The fuel reservoir 90 is preferably provided at immediate upstream of each fuel rail 32. The fuel reservoir 90 may form a fluid connection unit of the fuel pipe 34 and the fuel rail 32. It is possible to directly connect the fuel pipe 34 to the fuel rail 32 without providing the fuel reservoir 90.

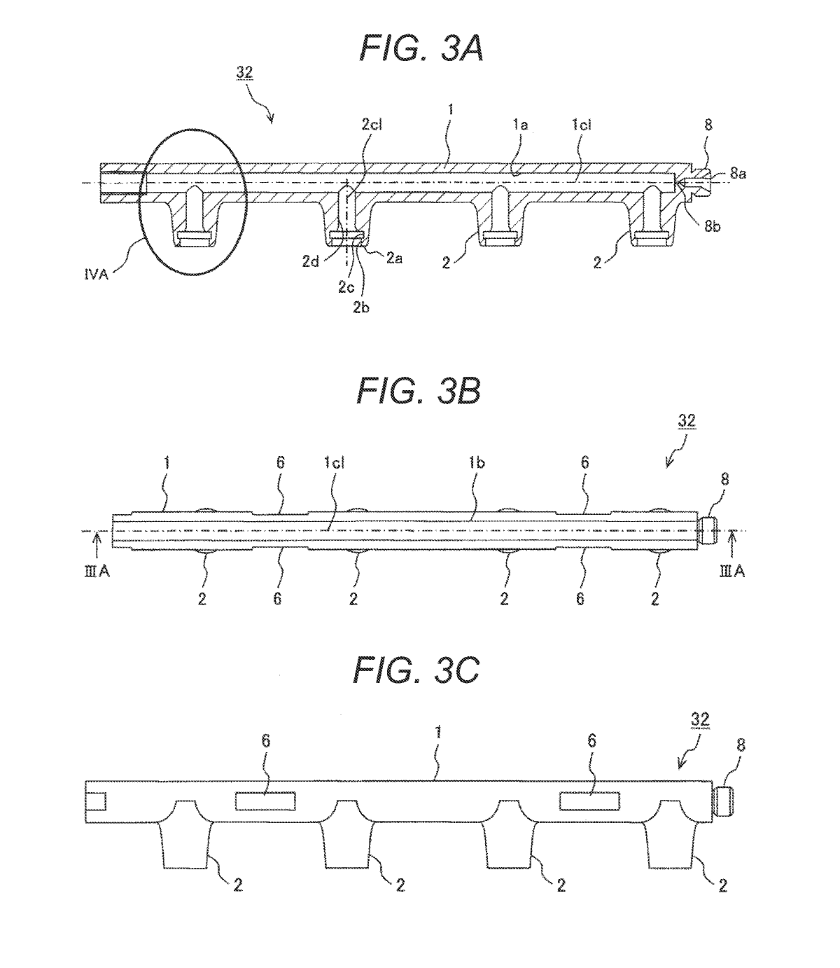

Next, a fuel rail will be described with reference to FIGS. 3A to 7.

FIG. 3A is a side sectional view of the fuel rail 32 and illustrates a sectional surface cut on a plane. The plane is in parallel with an axial 1cl direction (longitudinal direction) of the fuel rail body (straight pipe portion) 1 and a projecting direction (direction along a center line 2cl of the injector cup 2) from the fuel rail body 1 of the injector cup 2. The plane includes the center line 1cl of the fuel rail body 1.

The fuel rail 32 includes the fuel rail body 1, the injector cup (injector receiving portion) 2, and an inlet 8. The injector cup 2 is disposed so as to project in a vertical direction from the fuel rail body 1 to the center line 1cl. The inlet 8 is connected to the pipe 34 extending from the high-pressure fuel pump 36.

In the fuel rail body 1, a plurality of injector cups 2 is formed in the center line 1cl direction of the fuel rail body 1 with intervals between adjacent injector cups. In the embodiment, four injector cups 2 are disposed, and the injector cups 2 are disposed at equal intervals. A center hole 1a having a circular cross-section surface is formed at a center portion of the fuel rail body 1 from one end portion along the center line 1cl direction. In the fuel rail body 1, outer peripheral surfaces of a middle portion and both end portions of two adjacent injector cups 2 have a circular shape and are formed as a substantially cylindrical member by forming the center hole 1a. The center hole is included in an accumulator for storing high-pressure fuel sent from the high-pressure fuel pump 36 and distributes the fuel stored in the accumulator to a plurality of the injectors 28 (four injectors in the embodiment).

The center hole 1a is formed along, the center line 1cl direction from one end portion of the fuel rail body 1. However, the center hole 1a does not penetrate to another end portion. The inlet 8 is formed at the end portion on a side where the center hole 1a of the fuel rail body 1 does not penetrate. In the inlet 8, a fuel introduction hole 8a is formed by which a high-pressure fuel sent from the high-pressure fuel pump 36 is introduced into the accumulator 1a.

A pressure sensor (not illustrated) is provided at an end portion on a side where the center hole 1a of the fuel rail body 1 opens.

The injector cup 2 is a receiving portion of the injector 28 in which the injector 28 is mounted. An opening portion 2b to insert the injector 28 is formed on a tip surface 2a of the injector cup 2. On an inner side of the opening portion 2b, a receiving groove 2c which receives a locking portion disposed on the injector 28 side is formed. On an inner side of the receiving groove 2c, an inside/outside communication holes 2d are formed which communicates with the center hole (accumulator) 1a of the fuel rail body via the opening portion 2b and the receiving groove 2c.

The inside/outside communication hole 2d is formed as a hole having a circular cross-section surface and is formed in a direction vertical to the center hole 1a and the center line 1cl. The inside/outside communication hole 2d vertically crosses the center hole 1a and therefore may be called a cross hole 2d. An extension line of a center line of the inside/outside communication hole 2d (same as the center line 2cl of the injector cup 2) preferably crosses the center line 1cl of the center hole 1a. However, the extension line may not cross the center line 1cl. However, in the ease where the extension line of the center line of the inside/outside communication hole 2d is too apart from the center line 1cl of the center hole 1a, a strength of the fuel rail 32 might be reduced. Therefore, the extension line is preferably brought close to the center line 1cl within a half of the difference between a diameter of the fuel rail body 1 and a diameter of a root portion of the injector cup 2 or closer.

The inlet 8 and the injector cup 2 will be described later in detail.

FIG. 3B is an appearance view when viewed from an upper surface side of the fuel rail 32. FIG. 3C is a side surface view of the fuel rail 32. In the present description, a longitudinal direction and a lateral direction will be defined in FIG. 3A. The longitudinal direction and the lateral direction do not necessarily coincide with the longitudinal direction and the lateral direction in a mounting state of the fuel rail 32. Further, a direction vertical to an axial direction (a longitudinal direction and a direction along the center line 1cl) of the fuel rail body (straight pipe portion) 1 and a projecting direction from a fuel rail body 1 of the injector cup 2 (a direction along the center line 2cl of the injector cup 2) is defined as a width direction of the fuel rail 32 or the fuel rail body (straight pipe portion) 1.

As illustrated in FIGS. 3B and 3C, a fixing surface 6 of the fitting (bracket) 7 is formed on an outer peripheral surface of the fuel rail body 1. The fitting fixing surface 6 is disposed in a range including a part of the fuel rail body 1 which is furthest from a plane including the center lines 1cl and 2cl in a direction vertical to the center lines 1cl and 2cl. Further, in a direction along the center line 1cl, the fitting fixing surface 6 is formed between two adjacent injector cups 2.

The fitting fixing surface 6 is formed such that parallel surfaces are formed on both sides across the center line 1cl. Further, the fitting fixing surface 6 is formed at two portions in a direction along the center line 1cl and totally formed at four portions in the fuel rail body 1. In the embodiment, the fitting fixing surface 6 is formed in parallel with the center lines 1cl and 2cl. However, according to a mounting angle of the injector 28 with respect to an engine block, the fitting fixing surface 6 may be displaced from an angle parallel to the center line 2cl.

A thickness of the fuel rail body 1 is reduced by forming the fitting fixing surface 6. A stress is generated by receiving a pressure of a high pressure fuel in the fuel rail 32. As to be described later, this stress is concentrated at a joint between the fuel rail body 1 and the injector cup 2. Thicknesses of middle portions of two adjacent injector cups 2 are reduced when the fitting fixing surface 6 is formed. Therefore, an issue of a decrease in the strength of the fuel rail body 1 by the thickness reduction does not become apparent.

A plane portion 1b is formed from one end to another end along the center line 1cl in an upper portion (a side opposite to the side where the injector cup 2 is formed) of the fuel rail body 1. The plane portion 1b becomes a reference surface for processing the center hole the tip surface 2a of the injector cup 2, the opening portion 2b, the receiving groove 2c, the inside/outside communication note 2d, and the fitting fixing surface 6.

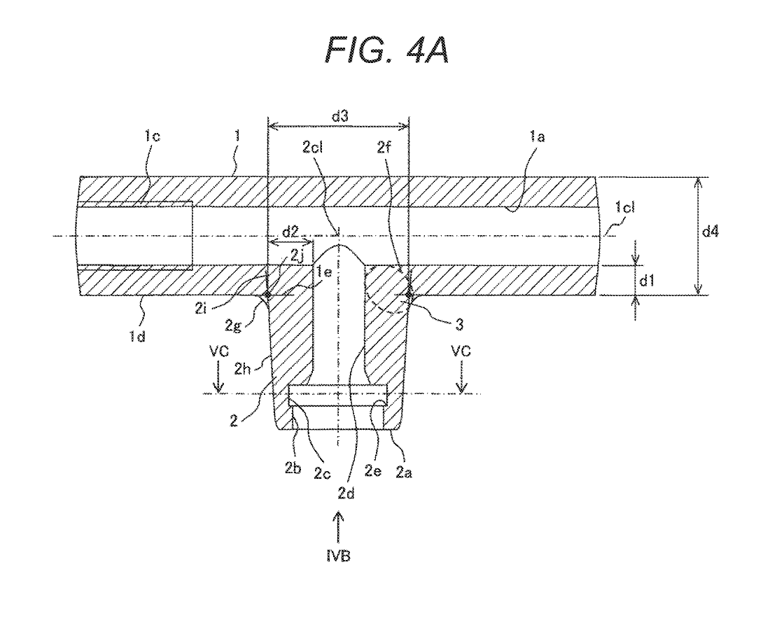

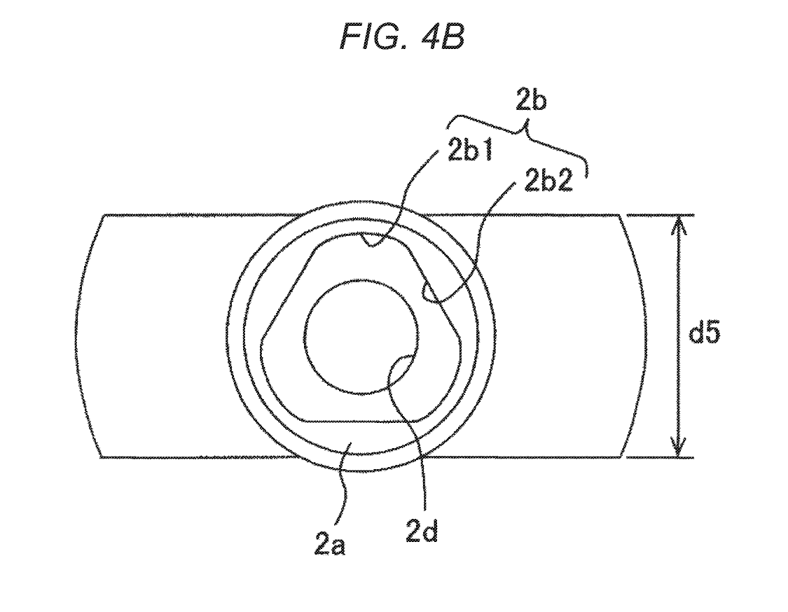

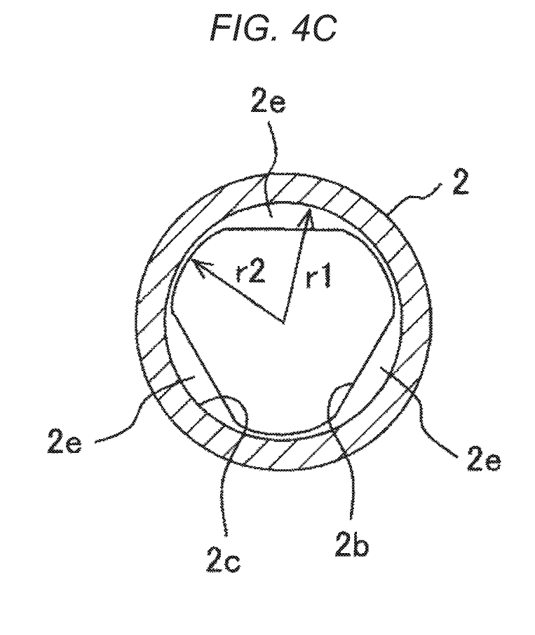

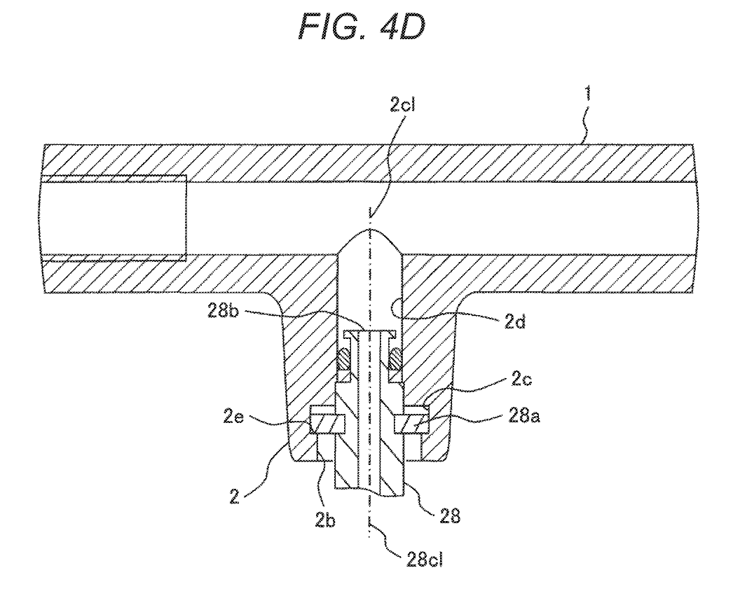

A structure of the injector cup 2 will be described in detail with reference to FIGS. 4A, 4B, 4C, and 4D. FIG. 4A is an enlarged sectional view of an IVA portion in FIG. 3A. FIG. 4B is an enlarged overall view when FIG. 4A is viewed from a direction of an arrow IVA. FIG. 4C is a sectional view illustrating a sectional surface along arrows VC-VC illustrated in FIG. 4B. FIG. 4D is an enlarged sectional view as in FIG. 4A and illustrates a state in which the injector 28 is assembled.

A screw portion 1c is formed at an end portion on a side where the center hole 1a of the fuel rail body 1 is opened. A pressure sensor is mounted to the screw portion 1c.

The opening portion 2b formed on the tip surface 2a of the injector cup 2 includes an inner peripheral surface in which three arc portions 2b1 and three straight line portions 2b2 are formed by alternately connecting. This inner peripheral surface has a shape in which the straight portions 2b2 form an inner angle of 60° each other, and both ends of each straight portion 2b2 are connected at the arc portion 2b1 In other words, a round shape is formed by the arc portion 2b1 at three peak portions of an equilateral triangle formed by three straight line portions 2b2.

In the receiving groove 2c formed on an inner side of the opening portion 2b, a peripheral surface which is a bottom surface of the groove has a circular shape in which the center line 2cl is a center. A radius r1 of the peripheral surface is larger than a radius r2 of the arc portion 2b1 of the opening portion 2b as illustrated in FIG. 4C. Further, by providing the straight line portion 2b2 in the opening portion 2b, an injector locking portion 2e is formed in which an injector-side locking portion 28a (refer to FIG. 4D) is locked on a side surface portion of the receiving groove 2c. In the injector-side locking portion 28a, a shape viewed from a projecting direction 2cl of the injector cup 2 in FIG. 4D is similar to opening shape of the opening portion 2b, and the injector-side locking portion 28a is set to be smaller than the opening portion 2b. As a result, the injector-side locking portion 28a can be inserted into an inner side (back side) of the injector cup 2 from the opening portion 2b, and the locking portion 28a can be locked to the injector locking portion 2e by rotating the injector 28 around the center axial line 28cl at 60°.

In the embodiment, the injector locking portion 2e is provided on an inner surface of the injector cup 2. However, the injector locking portion 2e may provided on an outer peripheral surface of the injector cup 2. In this case, a clip holder 66 and a clip plate 70 described in JP 2013-199943 A described in Background Art may be used. Both of reference signs of the clip holder 66 and the clip plate 70 are signs described in JP 2013-199943 A.

The fuel supply port 28b of the injector 28 is inserted into the inside/outside communication hole 2d of the injector cup 2 and receives supply of high pressure fuel from the inside/outside communication hole 2d.

A stress generated by a pressure received from a high pressure fuel is concentrated in a portion 2f (refer to FIG. 4A) in which the inside/outside communication hole (cross hole) 2d opens in the center hole 1a. This is because the center hole 1a receives a force extending in a diameter direction by receiving a pressure by a high pressure fuel, also the cross hole 2d receives a force extending in a diameter direction by receiving a pressure by a high pressure fuel, and a stress is concentrated in the fuel rail body 1 portion in which the cross hole 2d crosses the center hole 1a.

In the embodiment, with respect to the stress concentration, a necessary strength is secured by increasing the thickness d2 of a root portion of the injector cup 2 in comparison with the thickness d1 or the fuel rail body 1. In the embodiment, as to be described later, the injector cup 2 and the fuel rail body 1 are integrally molded by forging. Therefore, a round portion 2g is formed at a connection portion between the injector cup 2 and the fuel rail body 1. The thickness d2 of the root portion of the injector cup 2 is defined based on a cross point (a root portion of the injector cup 2) 2j between a segment 2i and a segment 1e. In the segment 2i, the center line 2cl direction is extended on the fuel rail body 1 side along an outer peripheral surface 2h of the injector cup 2. In the segment 1e, the center line 1cl direction is extended on the injector cup 2 side along an outer peripheral surface of the fuel rail body 1. That is, the thickness is defined by a thickness formed between the cross point 2j and the cross hole 2d. (a distance between the cross point 2j and the cross hole 2d). In this case, the outer peripheral surface of the injector cup 2 and the outer peripheral surface of the fuel rail body 1 are a portion viewed on a plane including the center lines 1cl and 2cl, and the segment 1e, the segment 2i, and the cross point 21 are viewed on the plane including the center lines 1cl and 2cl.

To increase the thickness d2 of the root portion of the injector cup 2, the diameter d3 of the root portion of the injector cup 2 is set to be larger than a longitudinal dimension (height) d4 of the fuel rail body 1 and a width direction dimension d5 of the fuel 1 body I (refer to FIG. 4B). In the embodiment, a cross-section surface of the fuel rail body 1 is circle. Therefore, the longitudinal direction dimension d4 and the width direction dimension d5 are equal. Further, a tip portion 2k of the injector cup 2 excluded from a stress concentration portion (refer to FIG. 4A) is tapered such that a diameter becomes smaller than a root portion of the injector cup 2. As a result, an increase in the weight of the fuel rail 32 can be prevented.

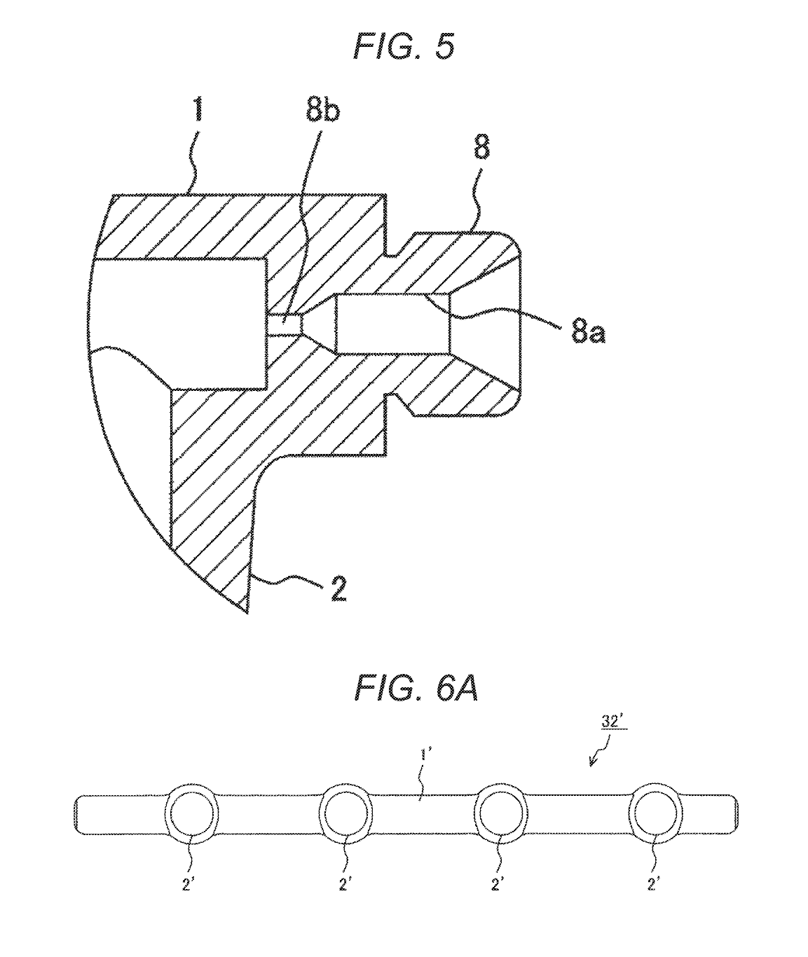

An inlet 8 will be described with reference to FIG. 5 FIG. 5 is a sectional view illustrating an enlarged end portion of the fuel rail body 1.

The inlet 8 is formed by machining (cutting) at an end portion on a side where the center hole 1a of the fuel rail body 1 is not penetrated. An outer diameter of the inlet 8 is smaller than an outer diameter of the fuel rail body 1. In the inlet 8, a fuel introduction hole 8a is formed along the center line 1cl. The fuel introduction hole 8a introduces a high pressure fuel sent from the high-pressure fuel pump 36 into the accumulator (center hole) 1a. A throttle 8b is formed in a portion connected to the accumulator 1a of the fuel introduction hole 8a. The fuel introduction hole 8a and the throttle 8b are formed by machining (cutting). The throttle 8b reduces a pressure pulsation of the high pressure fuel sent from the high-pressure fuel pump 36.

As described above, the fuel 34 extending from the high-pressure fuel pump 36 is connected via the fuel reservoir 90 or connected directly to the inlet 8.

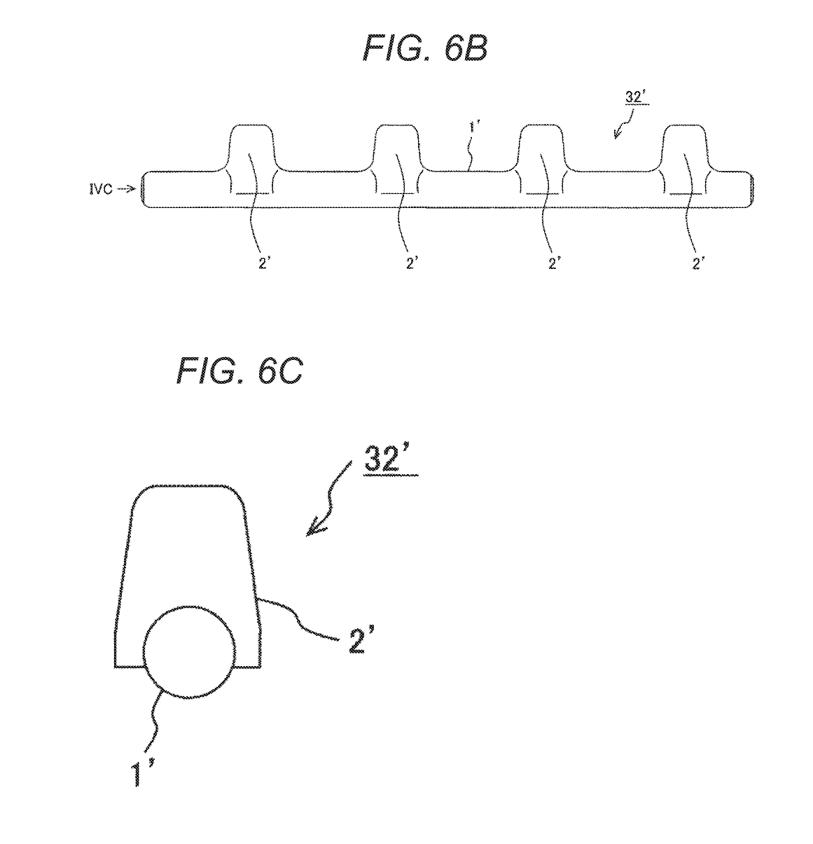

Next, a processing method for the fuel rail 32 will be described with reference to FIGS. 6A to 6C. FIG. 6A is an appearance view when a fuel rail material 32′ molded by forging is viewed from a lower side (injector cup portion 2′ side). FIG. 6B is a side surface view of the fuel rail material 32′ FIG. 6C is an appearance vie when the fuel rail material 32′ i s viewed from an IVC direction in FIG. 6B.

The fuel rail material 32′ according to the embodiment is made of a metal material. Specifically, a stainless material is used as the metal material. However, it is not limited to stainless. A block of a metal material is molded by forging in the shapes illustrated in FIGS. 6A to 6C. Specifically, the fuel rail material 32′ has a shape in which the fuel railbody 1′ and the injector cup portion 2′ are integrally molded. Specifically, in the embodiment, the fuel rail body and the injector mounting portion 2 are formed by post-processing the center hole 1a and the fuel supply port 2d on a material integrally molded by forging. Bubbles may be remained inside if the material is molded by casting. However, bubbles are not remained if the material is molded by forging. Therefore, a strength of the fuel rail 32 can be increased.

The plane 1b being a reference for the fuel rail body 1′ of the fuel rail material 32′ is machined (cut).

Then, the center hole 1a, the screw portion 1c, the injector cup 2, and the fitting fixing, surface 6 are machined on the fuel rail material 32′. The center hole 1a is formed by cutting by a drill. In the injector cup 2, a tip surface 2a is cut by lathe, and then the opening portion 2b, the receiving groove 2c, and the inside/outside communication hole 2d are cut by lathe. The fitting fixing surface 6 is formed by cutting an outer peripheral surface of the fuel rail body 1 by lathe. Therefore, in the fitting fixing surface 6, a thickness of the fuel rail body 1 is reduced when a vertical direction dimension is excessively increased with respect to the center line 1cl. Therefore, the fitting, fixing surface is set to a size needed to fix a fitting.

In the embodiment, the fuel rail body 1 and the injector cup 2 are integrally molded by forging. Therefore, a bearing force against a fuel pressure of the fuel rail 32 can be increased. Further, by reducing an outer diameter of the fuel rail body 1 and increasing the thickness d2 of a root portion of the injector cup 2, the strength of a connection portion (a root portion of the injector cup 2) between the fuel rail body 1 and the injector cup 2, in which stress concentration generates, can be increased, and a volume of the fuel rail 32 can be reduced. In addition, by tapering the injector cup 2, the volume of the fuel rail 32 can be further reduced.

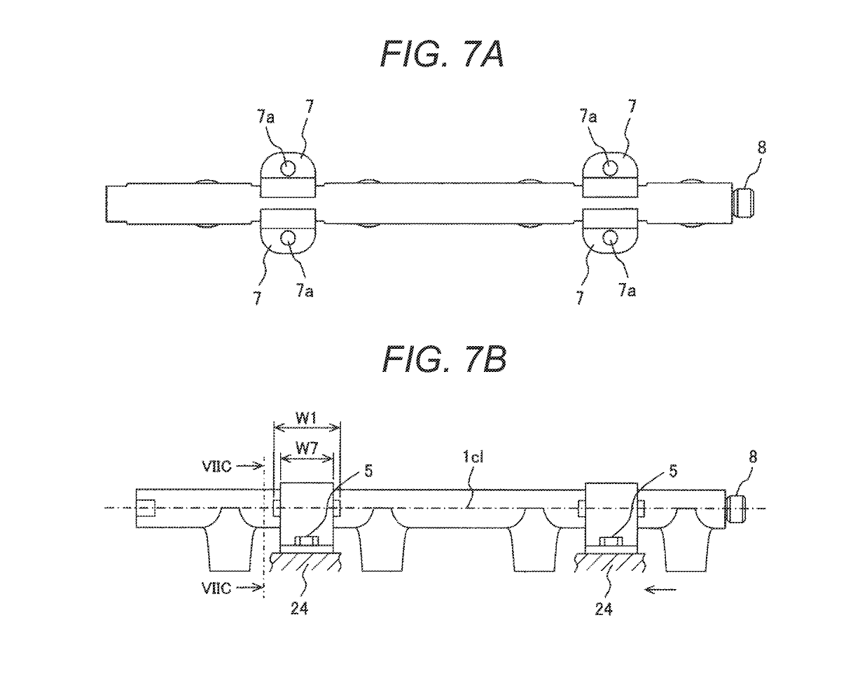

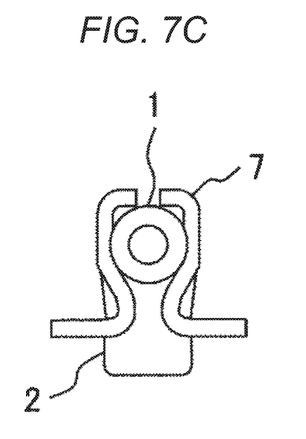

A mounting structure of the fuel rail 32 will be described with reference to FIGS. 7A, 7B, and 7C. FIG. 7A is an appearance view when the fuel rail 32 in which a fitting (bracket) 7 is assembled is viewed from an upper side. FIG. 7B is a side surface view illustrating a state in which the fuel rail 32 including the fitting (bracket) 7 is fixed to the engine block 24. FIG. 7C is a sectional view illustrating a sectional surface along arrows VIIC-VIIC in FIG. 7B.

The fitting 7 is fixed by welding on the fitting fixing surface 6 of the fuel rail body 1. The fittings 7 are fixed on the fitting fixing surfaces 6 disposed at four positions. A length W1 in the center line 1cl direction of the fitting fixing surface 6 is set to be longer than a length W2 in the center line 1cl direction of the fitting 7.

As a result, a mounting position of the fitting 7 can be adjusted in the center line 1cl direction. For example, the fuel rail 32 having same specification is made for two-type engines in which an interval between the injectors 28 is same, and a fixing position of the fuel rail 32 with respect to the engine block 24 is different. Then, the fuel rail 32 having the same specification can be used by adjusting a mounting position of the fitting 7 with respect to the fuel rail body 1. Specifically, the fitting fixing surface 6 includes an adjusting margin of a mounting position of the fitting 7 in a longitudinal direction of the fuel it body 1.

The present invention is not limited to the above-described embodiment and includes various variations. For example, the above-described embodiment describes the present invention in detail for clarification, and every configurations may not be necessarily included. Further, a part of a configuration of the embodiment can be added to, deleted from, and replaced from other configurations.

### REFERENCE SIGNS LIST

1 fuel rail body, 1′ fuel rail body portion, 1a center hole of fuel rail body 1 (accumulator), 1b plane portion, 1c screw portion, 1cl center line of fuel rail body 1, 1e segment extending along outer peripheral surface of fuel rail body 1, 2 injector cup, 2′ injector cup portion, 2a tip surface of injector cup 2, 2b opening portion, 2b1 arc portion, 2b2 straight line portion, 2cl center line of injector cup 2, 2c receiving groove, 2d inside/outside communication hole (cross hole), 2e injector locking portion, 2f portion where inside/outside communication hole (cross hole) 2d is opened toward center hole 1a, 2g round portion, 2h outer peripheral surface of injector cup 2, 2i segment extending along outer peripheral surface of injector cup 2, 2j cross point between segment 1e and segment 2i (root portion of injector cup 2), 2k tip portion of injector cup 2, 6 fitting fixing surface, 7 fitting (bracket), 8 inlet, 8a fuel introduction hole, 8b throttle, 22 direct-injection internal combustion engine, 23 spark plug, 24 engine block, 25 piston, 26 internal combustion chamber, 27 cylinder, 28 injector (fuel injection valve), 28a injector side locking portion, 28b fuel supply port of injector 28, 30 passage (through hole), 32 fuel rail, 32′ fuel rail material, 34 fuel pipe, 36 high-pressure fuel pump, 38 cam, 90 fuel reservoir

1. A fuel rail for an internal combustion engine, comprising:
a cylindrical fuel rail body; and
an injector mounting portion in which a hole to supply fuel to an injector is formed, and the injector is mounted,
wherein the injector mounting portion is integrally molded in the fuel rail body such that the fuel supply hole crosses a center hole of the fuel rail body,
a plurality of injector mounting portions is included along a longitudinal direction of the fuel body, and
a thickness of a root portion of the injector mounting portion is thicker than a thickness of the fuel rail body disposed between two adjacent injector mounting portions.

2. The fuel rail for an internal combustion engine according to claim 1, wherein, in the fuel rail body and the injector mounting portion, the center hole and the fuel supply port are post-processed on a material integrally molded by forging.

3. A fuel rail for an internal combustion engine according to claim 2, wherein a diameter of a root portion of the injector mounting portion is larger than a diameter of the fuel rail body disposed between two adjacent injector mounting portions in the fuel rail body.

4. The fuel rail for an internal combustion engine according to claim 2, wherein the injector mounting portion has a tapered shape in which a diameter of a tip portion is smaller than a diameter of a root portion.

5. The fuel rail for an internal combustion engine according to claim 4, wherein a fitting fixing surface to fix to an engine block is formed on an outer peripheral surface of the fuel rail body.

6. The fuel rail for an internal combustion engine according to claim 5, wherein the fitting is fixed on the fixing surface, and a length of the fixing surface is formed to be longer than a length of the fitting such that the fixing surface includes an adjusting margin of the fitting in a longitudinal direction of the fuel rail body.

7. The fuel rail for an internal combustion engine according to claim 4, wherein a plane portion is formed on the side opposite to the side where the injector mounting portion of the fuel rail body is formed.

8. The fuel rail for an internal combustion engine according to claim 4, wherein an injector locking portion to lock an injector on an inner side or an outer peripheral surface is formed in the injector mounting portion.
